(19) United States
(12) Patent Application Publication
(10) Pub. No.: US 2006/0102402 A1
(43) Pub. Date: May 18, 2006

(54) Device to raise a body component of a motor vehicle and method to operate such a device

(75) Inventors: Karl Birk, Ebersbach (DE); Wolfgang Diener, Schwaebisch Gmuend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/188,370

(22) Filed: Jul. 25, 2005

(30) Foreign Application Priority Data
Aug. 2, 2004 (DE) 10 2004 037 320.5

(51) Int. Cl. B62D 25/10

(52) U.S. Cl. 180/89.17

(57) ABSTRACT

A device for raising a body component of a motor vehicle, especially an engine hood, from a starting position into a receiving position can be returned to an operative state by opening and closing the body component after actuation. A method to operate such a device has the following steps: The device is activated, with the result that the body component is raised; it is recognized that the body component can be lowered again, whereupon a deactivation mechanism is actuated, with the result that the body component is lowered; the body component is opened and closed again, with the result that the device is returned to an operative state. Preferably, the device has a spring that relaxes when the body component is raised and that is tensioned when the body component is opened and closed.

The present invention relates to a device to raise a body component of a motor vehicle from a starting position into a receiving position as well as to a method to operate such a device.

### BACKGROUND OF THE INVENTION

Such devices (see, for example, DE 199 46 408) are in use in actual practice and serve primarily to raise the engine hood so as to provide better protection for a pedestrian or cyclist in case of a collision with a vehicle. After being activated by a suitable sensor system, the engine hood is raised so as to provide additional deformation space above the engine block.

Various types of such devices are known which differ especially in terms of the drive means employed. Thus, in addition to pyrotechnical systems, one can also use pneumatic or electric motor systems as well as combinations of various systems. Since not every actuation of the device actually involves a collision and thus a deformation of the engine hood, there is a need for a device that can be returned to its starting position and can thus be re-used.

Here, however, pyrotechnical systems have the drawback that, in any case, the vehicle owner incurs costs in order to reactivate the raising device, even if it was actuated erroneously, since in that case, new pyrotechnical propellant charges, for example, have to be installed in the vehicle.

Pneumatic systems, in turn, require the installation of a compressed air system or small compressor inside the vehicle and are consequently quite complex.

Electric motor systems likewise do not lend themselves for use in a raising device since the response times of electric motors are far too slow; moreover, these systems are relatively prone to malfunction and call for a great deal of maintenance.

Mechanical spring devices that combine the advantages of a short response time, low tendency to malfunction and low production costs exist so far only as pure raising devices that, after an erroneous actuation, either have to be returned to their starting position by a complicated manual procedure or else they are combined with one of the above-mentioned systems that then serves to reset the raised body component, and this, in turn, entails the already mentioned drawbacks.

Therefore, the objective of the present invention is to provide a raising device that can be returned to an operative state quickly, simply and without incurring any costs whenever it has been erroneously actuated.

### BRIEF DESCRIPTION OF THE INVENTION

According to the invention, with a device of the type mentioned above, it is provided that the device, once it has been actuated, can be returned to an operative state by opening and closing the body component. Such a method for operating such a device calls for the following steps: first of all, the device is activated, with the result that the body component is raised. Once it has been recognized that the body component can be lowered again, a deactivation mechanism is actuated, with the result that the body component is lowered. Subsequently, the body component is opened and closed again, with the result that the device is returned to an operative state.

In this manner, for example, after an erroneous actuation, the vehicle driver himself is able to quickly and simply return the device according to the invention to an operative state.

Preferably, the device has a raising fixture which is intended to be coupled to a body component that is to be raised, it also has an energy accumulator that is coupled to the raising fixture, a raising mechanism that can release the raising fixture, and a resetting mechanism by means of which the raising fixture can be returned to the starting position after having been activated. Thus, by activating the resetting mechanism, for example, in response to a sensor signal that is emitted immediately after the absence of a collision, any obstruction of the driver's view that might occur due to a raised front engine hood can quickly be eliminated.

In a preferred embodiment, the raising mechanism has a raising ratchet that can be actuated by a control element, thereby ensuring a rapid and reliable raising of the body component.

By the same token, the resetting mechanism can have a resetting ratchet that can likewise be actuated by a control element, which correspondingly allows a rapid lowering of the body component.

Preferably, the resetting mechanism interacts with a movable abutment which makes it possible to utilize gravity during the resetting process.

Since the energy accumulator preferably rests on the abutment, the energy accumulator can also be utilized to reset the body component.

The raising mechanism and the resetting mechanism are preferably arranged in such a way that the raising mechanism can again lock the raising fixture after an activation once the resetting mechanism has released the abutment. This translates into a simple and effective system that ensures a fast and reliable lowering of the body component.

Preferably, the body component is coupled to the abutment via a tie rod in such a way that, when the body component opens, the abutment can be adjusted against the action of the energy accumulator until it can be locked by the resetting mechanism. This results in an effective and easily performed restoration of the device to an operative state, which dispenses with the need for a dedicated reactivation mechanism.

According to an embodiment, the abutment is translationally adjustable, with the result that gravity can be utilized to reset the body component in an especially advantageous way.

Another embodiment of the device according to the invention comprises a rotatorily adjustable abutment that can be accommodated in the vehicle in a space-saving manner.

An inexpensive pressure spring can be used as the energy accumulator which, as a purely mechanical system, is particularly impervious to malfunction and is thus largely maintenance-free.

Furthermore, the use of a torsion spring as the energy accumulator offers the advantage of a compact design.

Therefore, the device advantageously has a spring that relaxes when the body component is raised and that is tensioned when the body component is opened and closed, which accounts for a simple and effective reversible mechanism.

In a preferred embodiment, the raising fixture is coupled to an adjusting lever which, in turn, is coupled to the energy accumulator. The use of such a lever offers the possibility of achieving a ratio between the opening path of the body component and the requisite force that is optimal for the application purpose in question.

According to a refinement of the invention, after the device has been activated, by opening the body component against the action of the energy accumulator, the adjusting lever can be pivoted until it can be locked in an intermediate position by the resetting mechanism. In this manner, when the body component is opened, less force is needed than if the starting position of the device had already been restored.

Preferably, the adjusting lever can be moved out of the intermediate position by closing the body component against the action of the energy accumulator and into the starting position, with the result that the energy accumulator is further pre-tensioned. Thus, during the final tensioning of the energy accumulator, gravity can be utilized in an advantageous manner.

The body component can be coupled to the adjusting lever by a coupling rod which, when the body component is completely opened and subsequently closed, passes through a dead center so that the adjusting lever can be driven in the same direction like a crank gear during the opening and closing of the body component. In this manner, the forces applied for opening and closing can likewise be used to tension the energy accumulator.

The body component to be raised is preferably an engine hood, which allows the use of the device for the above-mentioned protection of a cyclist or pedestrian in case of a collision.

### BRIEF DESCRIPTION OF THE DRAWINGS

Additional features and advantages of the invention ensue from the following description of several preferred embodiments with reference to the companying drawings. The drawings show the following:

FIG. 1a schematic side view of the front part of a vehicle;

FIG. 2a side view of a first embodiment of a device according to the invention in an operative starting position;

FIG. 3a side view of the device from FIG. 2 in an extended receiving position;

FIG. 4a side view of the device from FIG. 2 in a lowered but not yet operative state;

FIG. 5a side view of the device from FIG. 2 in a position that corresponds to a partially opened body component;

FIG. 6a side view of the device from FIG. 2 in a position with a completely opened body component, whereby the device is once again in the operative state;

FIG. 7a side view of a variant of the device from FIG. 2 in an operative starting position;

FIG. 8a side view of the device from FIG. 7 in an extended receiving position;

FIG. 9a side view of a second embodiment of a device according to the invention in an operative state in a starting position;

FIG. 10a side view of the device from FIG. 9 in a receiving position;

FIG. 11a side view of the device from FIG. 9 after the lowering of the body component;

FIG. 12a side view of the device from FIG. 9 in an intermediate position that corresponds to the opening of the body component;

FIG. 13a side view of the device from FIG. 9 in a position that corresponds to the closing of the body component;

FIG. 14a side view of a third embodiment of a device according to the invention in an operative starting position;

FIG. 15a side view of the device from FIG. 14 in an extended receiving position;

FIG. 16a side view of the device from FIG. 14 in a position after the lowering of the body component;

FIG. 17a side view of the device from FIG. 14 in a position that corresponds to a partially opened body component; and

FIG. 18a side view of the device from FIG. 14 in an operative state with a completely opened body component.

### DETAILED DESCRIPTION OF THE INVENTION

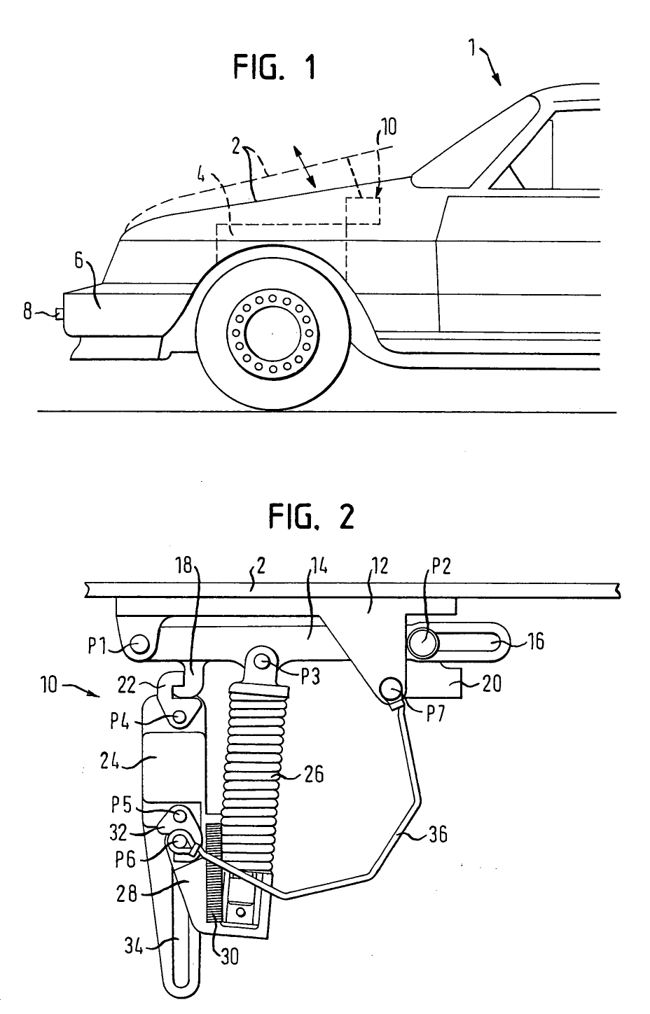

FIG. 1 shows a vehicle 1 that is equipped with a device according to the invention for raising a body component, here, an engine hood 2. The device is only schematically indicated and designated with the reference numeral 10. The vehicle 1 is normally driven with a closed engine hood 2 (solid line) that covers the engine compartment containing, among other things, an engine block 4. In case of a collision, for example, with a pedestrian, which can be detected, for instance, by means of a sensor 8 attached to the bumper 6 of the vehicle 1, the device 10—in response to a signal generated by the sensor 8—raises the engine hood 2 into a receiving position (shown by a broken line) in order to provide additional deformation space for the pedestrian by enlarging the distance between the engine hood 2 and the engine block 4.

A first embodiment of a raising device 10 according to FIG. 2 comprises a raising fixture 12 which is intended to be coupled to the body component 2 that is to be raised, as well as a raising lever 14, which—in the starting position of the device 10 shown in FIG. 2—is arranged parallel below the raising fixture 12 and is connected thereto at a point P1 so as to pivot. The raising lever 14 has a slot 16 by means of which it is movably connected to an attachment fixture 20 at a point P2, whereby the attachment fixture 20 is to be permanently mounted on the car body. Moreover, a hook 18 is mounted on the raising lever 14 in such a way that the hook 18 can be grasped by a raising ratchet 22 mounted on a ratchet fixture 24 that can pivot at a point P4. The ratchet fixture 24, in turn, is rigidly connected to the car body. Together with an actuating member (not shown), the raising ratchet 22 forms a raising mechanism that can release the raising fixture 12 in case of activation.

Moreover, on the ratchet fixture 24, there is a resetting ratchet 32 that is connected to the ratchet fixture 24 at a point P5 so as to pivot. The resetting ratchet 32 engages a movable abutment 28 at a point P6 on which an energy accumulator 26 in the form of a pressure spring rests that is also connected to the raising lever 14 at a point P3 so as to pivot. The ratchet fixture 24 has a slot 34 into which a section of the movable abutment 28 engages and in which the latter can slide after the resetting ratchet 32 has been opened. An auxiliary spring 30 is provided that rests with one of its ends on the ratchet fixture 24 and with its other end on the movable abutment 28. Both springs 26, 30 are pre-tensioned in the starting position shown in FIG. 2. Moreover, the raising device 10 has a tie rod in the form of a holding cable 36 that is connected to the movable abutment 28 at a point P6 so as to pivot, and to the raising fixture 12 at a point P7 so as to pivot.

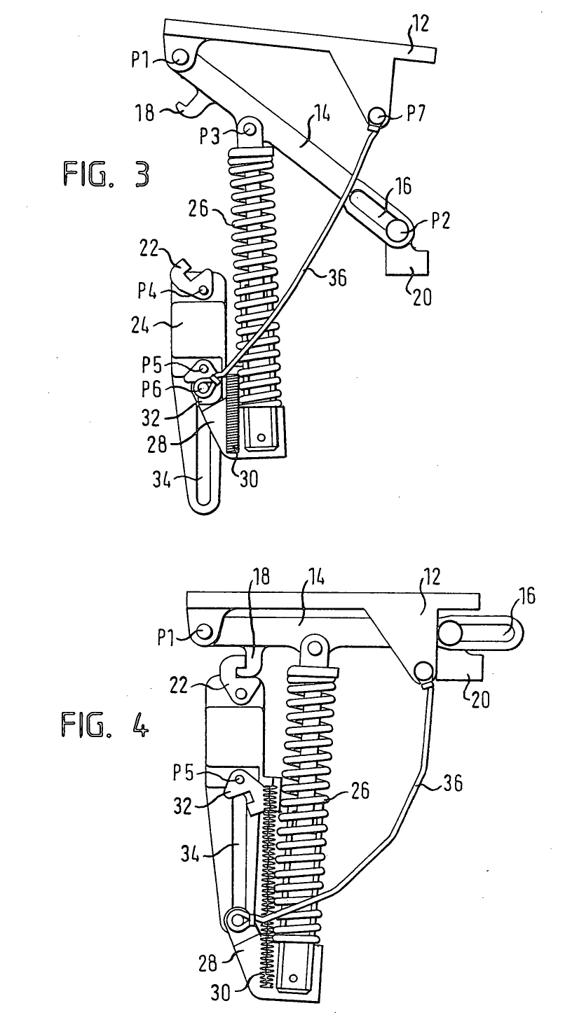

In response to a signal of the sensor 8, which indicates a collision with a pedestrian, the actuating member (not shown) rotates the raising ratchet 22 around the point P4, with the result that the hook 18 and thus the raising lever 14 are released so that, due to the pre-tensioning of the pressure spring 26, the raising lever 14, and with it the raising fixture 12, as well as the coupled body component 2 of the vehicle, move abruptly upwards and the device 10 assumes the position shown in FIG. 3. In this manner, for example, an engine hood 2 coupled to the raising fixture 12, can be raised to the receiving position within a very short period of time. The final phase of the movement is influenced by the holding cable 36 as well as by the slot 16, which serve as a limit stop, in a manner of speaking, when the engine hood 2 is raised.

If the anticipated collision does not occur, in order to eliminate any obstruction of the driver's field of vision as quickly as possible, it is desirable to return the engine hood 2 to a closed position. For this purpose, there is a resetting mechanism that comprises the resetting ratchet 32 which is pivoted by an actuating member (not shown) around the point P5 in such a way that it releases the movable abutment 28, with the result that the abutment 28 moves downwards inside the slot 34 and, during this movement, due to the coupling via the spring 26, pulls the raising lever 14 and thus the raising fixture 12 down into a lowered position of the body component 2. The pre-tensioned auxiliary spring 30 has the function of supporting the weight that is exerted on the engine hood 2 and on the abutment 28. After the movable abutment 28 has been released by the resetting mechanism, the raising ratchet 22 engages in the hook 18 again, with the result that the raising fixture 12 and thus the engine hood 2 are locked, as can be seen in FIG. 4.

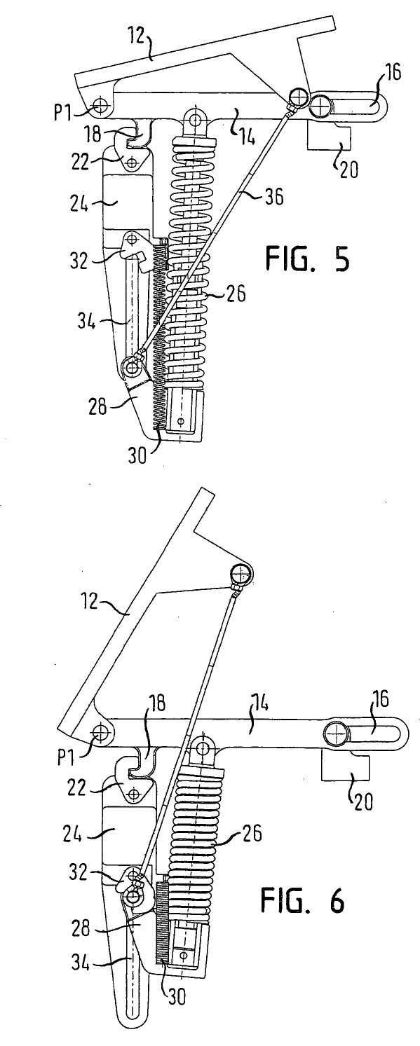

In order to subsequently return the device 10 to an operative state, the engine hood 2 is opened, as shown in FIGS. 5 and 6. Here, the raising fixture 12 coupled to the engine hood 2 is rotated counterclockwise around the now stationary point P1, a process in which it pulls the movable abutment 28 in the slot 34 via the holding cable 36 upwards against the action of the springs 26 and 30 until the abutment 28 latches in the resetting ratchet 32 again. Thus, the device 10, after the engine hood 2 has been closed, is once again in the operative starting position shown in FIG. 2.

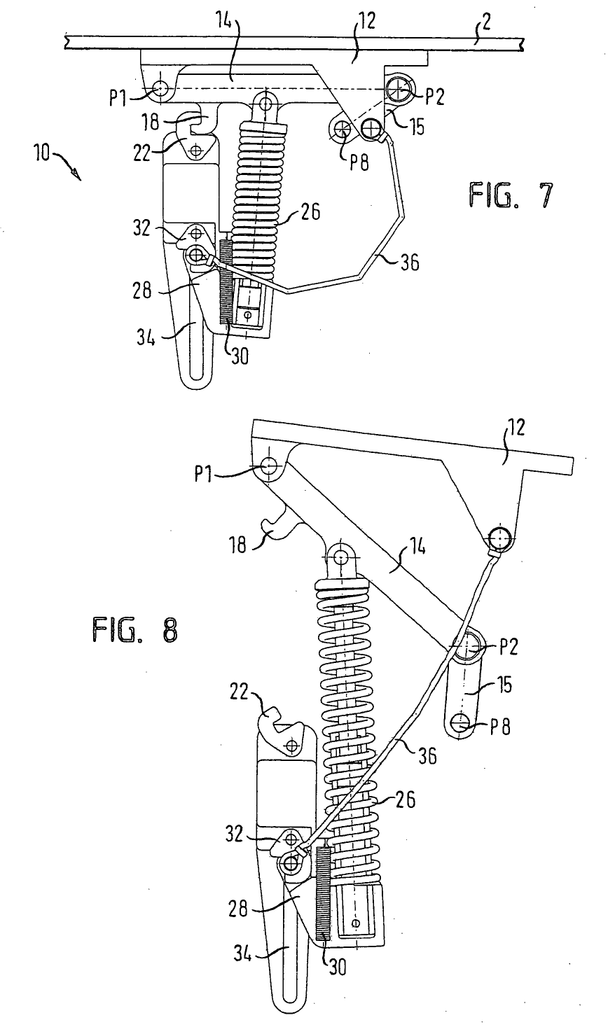

FIGS. 7 and 8 show the operative starting position or the receiving position of a variant of the first embodiment of the device 10, in which the slot 16 in the raising lever 14 is replaced by a second lever 15 that is connected to the raising lever 14 at the point P2 so as to pivot and is mounted on the vehicle body at a point P8 so as to pivot. Since this variant is otherwise identical to the embodiment shown in FIGS. 2 to 6, this variant will not be elaborated upon further here.

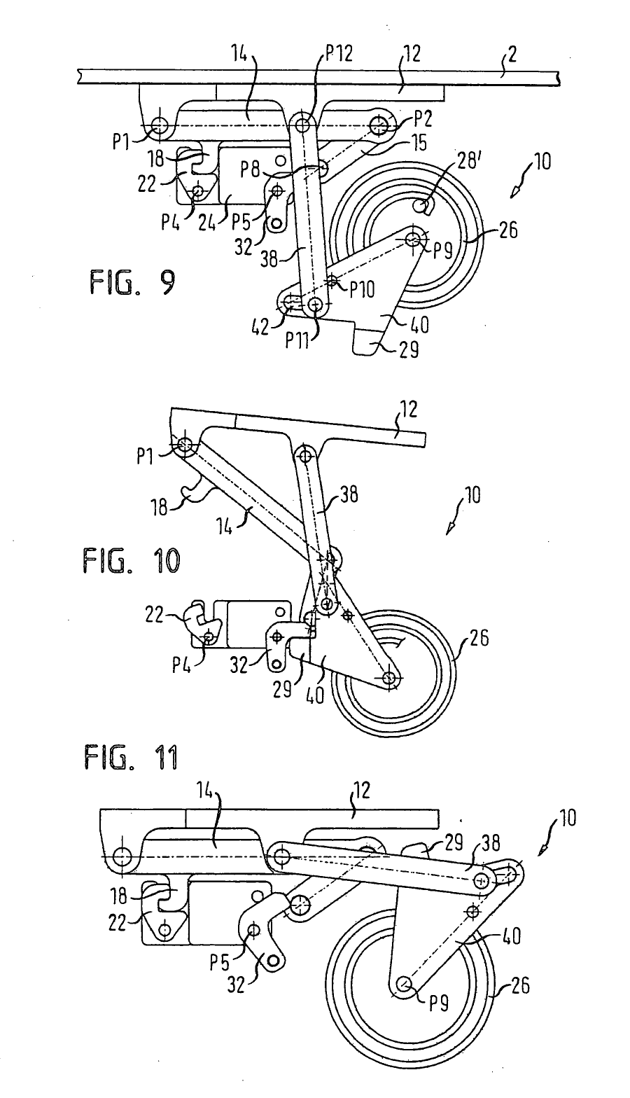

FIGS. 9 to 13 show a second embodiment of a device 10 according to the invention, whereby the same components are designated with the same reference numerals so that merely the differences of the second embodiment as compared to the first embodiment will be discussed below. Instead of the pressure spring 26, the device 10 according to the second embodiment has a torsion spring 26 as the energy accumulator that is connected at one of its ends to an adjusting lever 40 at a point P10 and at its other end to the body of the vehicle (indicated by abutment 28′). The adjusting lever 40 has a stop 29 that is connected in one piece to said adjusting lever 40 and said stop 29 can engage in a resetting ratchet 32 and is mounted on the vehicle body at a point P9 so as to rotate. Furthermore, the adjusting lever 40 has a slot 42 into which a coupling rod 38 engages at a point P11 so as to slide, whereby the coupling rod 38 is connected at one of its ends to the raising fixture 12 at a point P12 so as to pivot.

In the operative starting position of the device 10 shown in FIG. 9, the torsion spring 26 is strongly pre-tensioned. When the raising mechanism is now actuated and the raising ratchet 22 is pivoted around the point P4, it releases the hook 18, with the result that the raising fixture 12—due to the pre-tensioning of the torsion spring 26 and due to the fact that this torsion spring 26 is coupled to the raising fixture 12 via the coupling rod 38—moves abruptly upwards and thus moves an engine hood 2 connected thereto into a receiving position. Here, the coupling rod 38 also serves as a limit stop.

This receiving position shown in FIG. 10 is characterized in that the stop 29 engages the resetting ratchet 32 and thus prevents any further movement due to the remaining pre-tensioning of the torsion paring 26 (clockwise) whereby, unlike the first embodiment, the resetting ratchet 32 was not yet engaged with the stop 29 in the starting position shown in FIG. 9.

From the receiving position, the device 10 can be moved into the position with the lowered engine hood 2 shown in FIG. 11 in that the resetting ratchet 32 is pivoted around the point P5, with the result that it releases the limit stop 29 and the torsion spring 26 that is still under pre-tension pivots the adjusting lever 40 further around the point P9. In this process, the adjusting lever 40—via the coupling rod 38—pulls the raising fixture 12 and the raising lever 14 coupled thereto downwards into a lowered position in which the raising ratchet 22 can engage the hook 18 again and thus can lock the raising fixture 12 in the lowered position. Therefore, the raising as well as the lowering of the engine hood 2 are achieved in that the adjusting lever 40 is driven both times in the same direction, namely, clockwise in the embodiment shown.

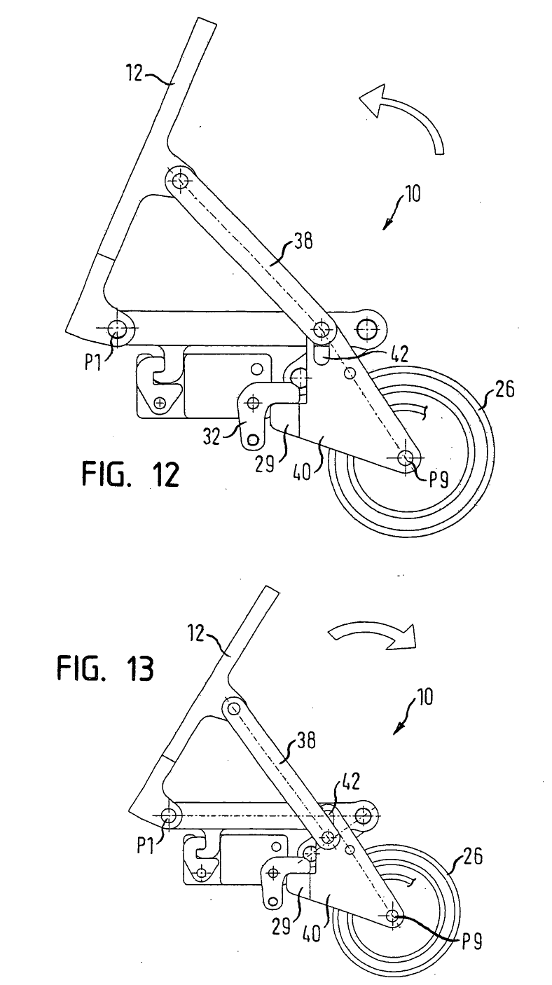

In order to now pre-tension the torsion spring 26 and thus return the device 10 to an operative state, as is shown in FIG. 12, the engine hood 2 is first opened completely, with the result that the adjusting lever 40 is rotated against the action of the torsion spring 26 counterclockwise until it latches with the limit stop 29 in the intermediate position on the resetting ratchet 32 as shown in FIG. 12.

From this intermediate position, the device 10 is returned to the operative state by a subsequent closing of the engine hood 2, as shown in FIG. 13, whereby the adjusting lever 40 is rotated further counterclockwise and against the action of the torsion spring 26 around the point P9 until, after the engine hood has been completely closed, it is once again in the starting position with the pre-tensioned torsion spring 26, as shown in FIG. 9.

When the engine hood 2 is opened and closed, the adjusting lever 40 is only driven in one direction, namely, counterclockwise, like a crank gear. In doing so, it passes through a dead center that is reached when the engine hood is in the maximally opened position shown in FIG. 12 and when the coupling rod 38 engages the outer end of the slot 42. In this manner, a displacement of the line of action of the force transferred to the adjusting lever 40 is achieved, thus making it possible to use the opening as well as the closing motion of the engine hood 2 to tension the torsion spring 26.

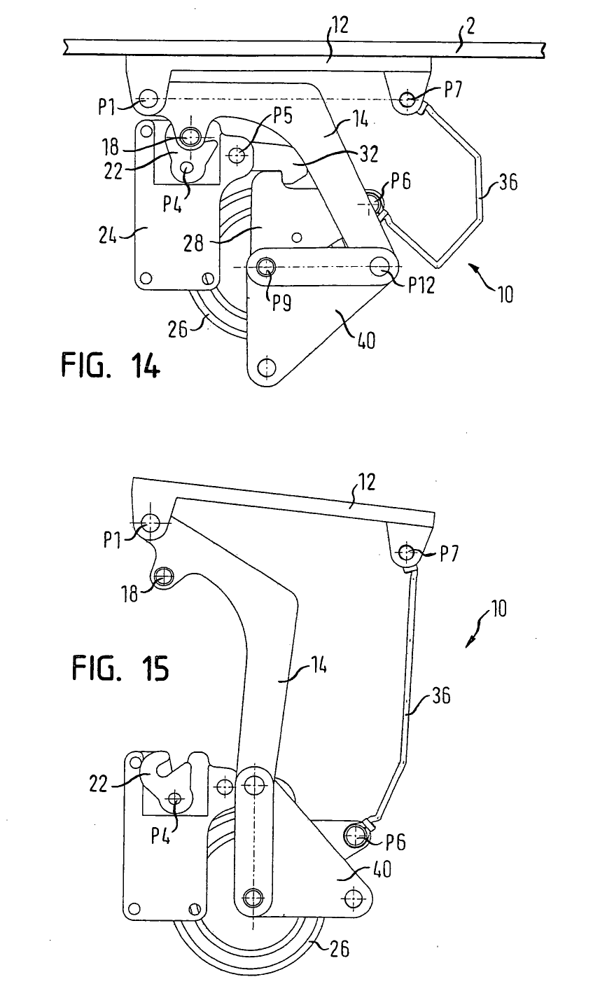

FIGS. 14 to 18 show a third embodiment of a device 10 according to the invention that, as an energy accumulator, uses a torsion spring 26 that engages at one of its ends with a movable adjusting lever 40 and at its other end with a movable abutment 28, whereby the abutment 28 and the adjusting lever 40 are mounted on the car body so as to pivot at a shared point P9 and they can pivot independent of each other around this point.

In the operative starting position shown in FIG. 14, the torsion spring 26 is under pre-tension and the abutment 28 is held in position by a resetting ratchet 32. Once again, there is a holding cable 36 that is attached at one of its ends to the abutment 28 at a point P6 and at its other end to the raising fixture 12 at a point P7.

The raising lever 14 is connected to the adjusting lever 40 at a point P12 so as to pivot and, after the release of the hook 18 by the raising ratchet 22, due to the pre-tensioning of the torsion spring 26, moves together with the adjusting lever 40 counterclockwise and upwards, with the result that the device 10 is returned to the receiving position shown in FIG. 15. The tie rod 36, like the raising lever 14, which is present here in an angled form, serves as the limit stop for the hood raising movement.

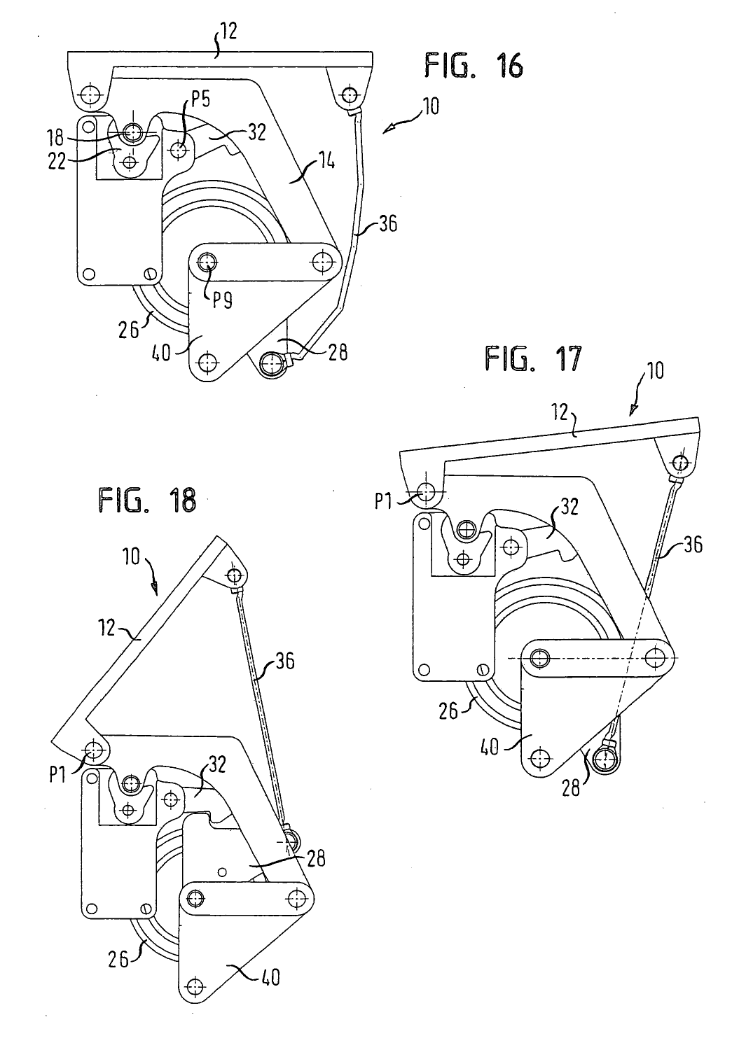

In order to return the engine hood 2 to a lowered position, the resetting ratchet 32 is pivoted around a point P5, thus releasing the abutment 28, which subsequently pivots clockwise by about 90° downwards due to gravity and to a possible residual tension of the torsion spring 26, whereby said abutment lowers the raising fixture 12 and the raising lever 14 coupled thereto via the tie rod 36. Then the hook 18 can once again be engaged by the raising ratchet 22, so that the engine hood 2 is locked in the lowered position (FIG. 16).

FIGS. 17 and 18 show how the device 10 is returned to an operative state after being activated. For this purpose, the engine hood 2 is opened, with the result that the raising fixture 12 rotates counterclockwise around the point P1 and, due to the connection by the tie rod 36, rotates the abutment 28 by about 90° counter-clockwise, so that, in the maximally opened position of the engine hood 2 shown in FIG. 18, the resetting ratchet 32 engages the abutment 28 again and thus secures the device 10 against the action of the torsion spring 26 in an operative state that is reached by the subsequent closing of the engine hood 2.

1. A device to raise a body component of a motor vehicle from a starting position into a receiving position, characterized in that, once it has been actuated, it can be returned to an operative state by opening and closing said body component.

2. The device according to claim 1, characterized in that a raising fixture is provided which is intended to be coupled to said body component that is to be raised, and an energy accumulator that is coupled to said raising fixture, a raising mechanism that can release said raising fixture, and a resetting mechanism by means of which said raising fixture can be returned to said starting position after having been activated.

3. The device according to claim 2, characterized in that said raising mechanism has a raising ratchet that can be actuated by a control element.

4. The device according to claim 2, characterized in that said resetting mechanism has a resetting ratchet that can be actuated by a control element.

5. The device according to claim 2, characterized in that said resetting mechanism interacts with a movable abutment.

6. The device according to claim 5, characterized in that said energy accumulator rests on said abutment.

7. The device according to claim 5, characterized in that said raising mechanism and said resetting mechanism are arranged in such a way that said raising mechanism can again lock said raising fixture after an activation once said resetting mechanism has released said abutment.

8. The device according to claim 5, characterized in that said body component is coupled to said abutment via a tie rod in such a way that, when said body component opens, said abutment can be adjusted against an action of said energy accumulator until it can be locked by said resetting mechanism.

9. The device according to claim 5, characterized in that said abutment is translationally adjustable.

10. The device according to claim 5, characterized in that said abutment is rotatorily adjustable.

11. The device according to claim 9, characterized in that said energy accumulator is a pressure spring.

12. The device according to claim 10, characterized in that said energy accumulator is a torsion spring.

13. The device according to claim 12, characterized in that said raising fixture is coupled to an adjusting lever which, in turn, is coupled to said energy accumulator.

14. The device according to claim 13, characterized in that, after said device has been activated, by opening the body component against an action of said energy accumulator, said adjusting lever can be pivoted until it can be locked in an intermediate position by said resetting mechanism.

15. The device according to claim 14, characterized in that said adjusting lever can be moved out of said intermediate position by closing said body component against an action of said energy accumulator and into said starting position, with the result that said energy accumulator is further pre-tensioned.

16. The device according to claim 15, characterized in that said body component is coupled to said adjusting lever by a coupling rod which, when said body component is completely opened and subsequently closed, passes through a dead center so that said adjusting lever can be driven in the same direction like a crank gear during opening and closing of said body component (2).

17. A method for operating a device to raise a body component from a starting position into a receiving position, characterized by the following steps:
the device is activated, with the result that said body component is raised;
t is recognized that said body component can be lowered again, whereupon a deactivation mechanism is actuated, with the result that said body component is lowered;
said body component is opened and closed again, with the result that device is returned to an operative state.

18. The method according to claim 17, characterized in that said device has a spring that relaxes when said body component is raised, and in that said spring is tensioned when said body component is opened and closed.

19. The method according to claim 17, characterized in that said body component is an engine hood.
